(19) United States
(12) Patent Application Publication
(10) Pub. No.: US 2019/0100039 A1
(43) Pub. Date: Apr. 4, 2019

(54) AIR BLOWER AND PRINTING SYSTEM

(71) Applicant: Roland DG Corporation, Hamamatsu-shi (JP)

(72) Inventor: Hisaya MATSUOKA, Hamamatsu-shi (JP)

(21) Appl. No.: 16/149,335

(22) Filed: Oct. 2, 2018

(30) Foreign Application Priority Data
Oct. 2, 2017 (JP) 2017-192477

(51) Int. Cl. B41J 11/00

(52) U.S. Cl. CPC B41J 11/0015

(57) ABSTRACT

An air blower includes an opposing plate above a table and on an upstream side of ink heads and facing the table, vents penetrating the opposing plate, a blower fan that causes air to flow toward the vents and sends air to a recording medium through the vents, and a heat source that is between the vents and the blower fan and generates heat. The blower fan sends air toward a portion of the recording medium on an upstream side of the ink heads before ink is discharged from the ink heads onto the recording medium and while ink is being discharged from the ink heads onto the recording medium, and sends air toward ink discharged onto the recording medium after discharge of ink from the ink heads onto the recording medium is completed.

### CROSS REFERENCE TO RELATED APPLICATIONS

This application claims the benefit of priority to Japanese Patent Application No. 2017-192477 filed on Oct. 2, 2017. The entire contents of this application are hereby incorporated herein by reference.

### BACKGROUND OF THE INVENTION

### 1. Field of the Invention

The present invention relates to an air blower and a printing system.

### 2. Description of the Related Art

An ink jet printer that has been known to date performs printing on a recording medium in an ink jet manner. The ink jet printer of this type includes, for example, a placing table on which a recording medium is placed and ink heads that discharge ink onto the recording medium placed on the placing table.

Japanese Patent Application No. 2002-337331, for example, discloses an ink jet printer including a preliminary heating unit that preliminarily heats a recording medium and a drying body unit that heats the recording medium after printing in order to increase a drying efficiency of ink discharged onto the recording medium. The preliminary heating unit and the drying body unit are provided to enhance fixing of ink on the recording medium. In Japanese Patent Application No. 2002-337331, heated air is sent to each of the preliminary heating unit and the drying body unit so that the preliminary heating unit and the drying body unit are individually heated. In this configuration, the recording medium passes through insertion holes of the heated preliminary heating unit and the drying body unit to be thereby heated.

In the ink jet printer of Japanese Patent Application No. 2002-337331, the preliminary heating unit and the drying body unit are formed independently of each other, and thus, the size of the ink jet printer tends to be large. The large ink jet printer has the drawback of requiring a large installation space. In addition, the ink jet printer of Japanese Patent Application No. 2002-337331 heats the recording medium indirectly by heating the preliminary heating unit and the drying body unit, and has the drawback of relatively low thermal efficiency.

### SUMMARY OF THE INVENTION

Preferred embodiments of the present invention provide air blowers and printing systems capable of efficiently performing heating of recording media and drying of ink discharged onto the recording media.

An air blower according to a preferred embodiment of the present invention is an air blower provided in an ink jet printer and sends air toward a recording medium. The ink jet printer includes a placing table on which a recording medium is placed, an ink head movable in a main scanning direction and including a nozzle that discharges ink onto the recording medium placed on the placing table and a nozzle surface provided with the nozzle, and a first moving mechanism that moves one of the placing table and the ink head relative to another in a sub-scanning direction perpendicular or substantially perpendicular to the main scanning direction. The air blower sends air toward the recording medium. The air blower includes an opposing plate disposed above the placing table and on an upstream side of the ink head in the sub-scanning direction; a plurality of vents penetrating the opposing plate; a case defining an internal space together with the opposing plate; a blower fan that is disposed in the internal space, causes air to flow toward the vents, and sends air to the recording medium through the vents; and a heat source that is disposed between the vents and the blower fan in the internal space and generates heat, wherein the blower fan sends air toward a portion of the recording medium located on the upstream side of the ink head before ink is discharged from the ink head onto the recording medium or while ink is being discharged from the ink head onto the recording medium, and the blower fan sends air toward ink discharged onto the recording medium after discharging of ink from the ink head onto the recording medium is completed.

In an air blower according to a preferred embodiment of the present invention, air flowing from the blower fan through the vents is heated by the heat source disposed between the blower fan and the vents. Accordingly, the heated air is sent to the surface of the recording medium and heats the surface of the recording medium. The blower fan of the air blower sends air toward a portion of the recording medium located on an upstream side of the ink head before ink is discharged from the ink head onto the recording medium and while ink is being discharged from the ink head onto the recording medium. Accordingly, the surface of the recording medium is heated before ink is discharged onto the recording medium, and thus, fixing of the ink discharged onto the recording medium is enhanced. The blower fan sends air to ink discharged onto the recording medium after discharging of ink from the ink head onto the recording medium is completed. Accordingly, drying of ink discharged onto the surface of the recording medium is promoted. In this manner, the air blower performs preliminary heating of the recording medium and drying of ink in accordance with a progress status of printing on the recording medium. That is, the single air blower performs both preliminary heating of the recording medium and drying of ink, and thus, a required installation space is able to be reduced.

In a preferred embodiment of the present invention, heating of the recording medium and drying of ink discharged onto the recording medium is efficiently performed.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view of a printing system according to a preferred embodiment of the present invention.

FIG. 2 is a side view of a printing system according to a preferred embodiment of the present invention.

FIG. 3 is a bottom view of an ink head unit according to a preferred embodiment of the present invention.

FIG. 4 is a perspective view illustrating a portion of a printing system according to a preferred embodiment of the present invention.

FIG. 5 is a block diagram of a printing system according to a preferred embodiment of the present invention.

FIG. 6 is a perspective view illustrating an attachment state of an air blower according to a preferred embodiment of the present invention.

FIG. 7 is a perspective view of an air blower according to a preferred embodiment of the present invention.

FIG. 8 is a perspective view illustrating a state in which a case of an air blower according to a preferred embodiment of the present invention is detached.

FIG. 9 is a cross-sectional view of an air blower according to a preferred embodiment of the present invention.

FIG. 10 is a side view illustrating a portion of a printing system according to a preferred embodiment of the present invention.

FIG. 11 is a plan view illustrating a portion of an opposing plate according to a preferred embodiment of the present invention.

FIG. 12 is a front view illustrating a portion of a printer according to a preferred embodiment of the present invention.

FIG. 13 is a schematic view illustrating one state of a print operation by a printing system according to a preferred embodiment of the present invention.

FIG. 14 is a schematic view illustrating one state of a print operation by a printing system according to a preferred embodiment of the present invention.

FIG. 15 is a schematic view illustrating one state of a print operation by a printing system according to a preferred embodiment of the present invention.

FIG. 16 is a schematic view illustrating one state of a print operation by a printing system according to a preferred embodiment of the present invention.

FIG. 17 is a schematic view illustrating one state of a print operation by a printing system according to a preferred embodiment of the present invention.

### DETAILED DESCRIPTION OF THE PREFERRED EMBODIMENTS

Air blowers according to preferred embodiments of the present invention and printing systems including the air blowers and ink jet printers (hereinafter referred to as a printer) will be described with reference to the drawings. Preferred embodiments described here are, of course, not intended to particularly limit the present invention. Elements and features having the same functions are denoted by the same reference characters, and description for the same members and elements will not be repeated or will be simplified as appropriate.

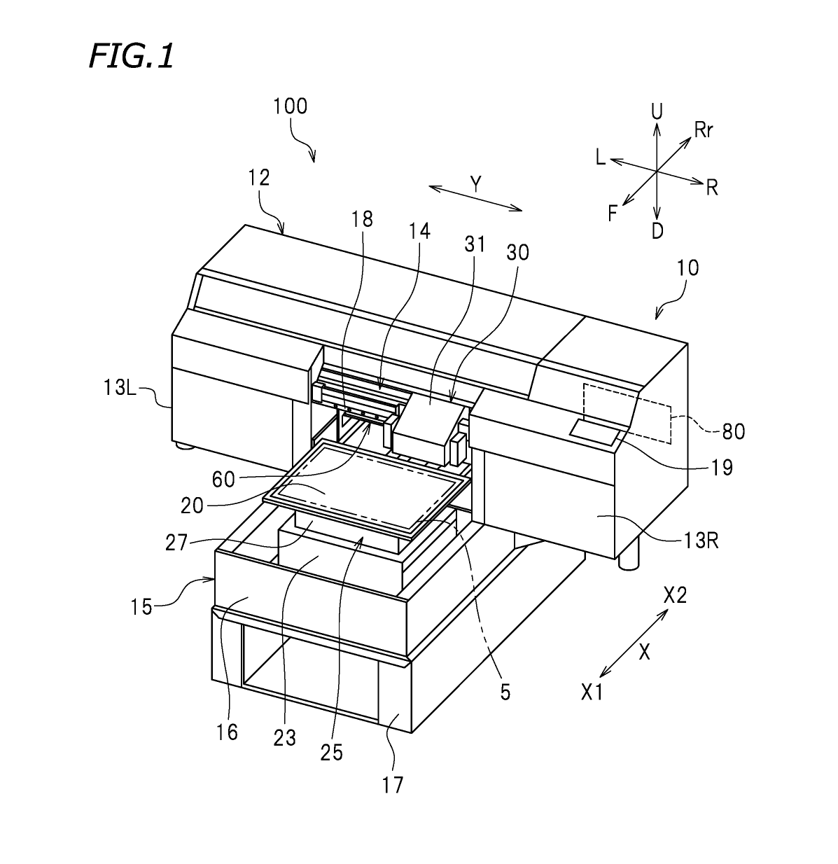

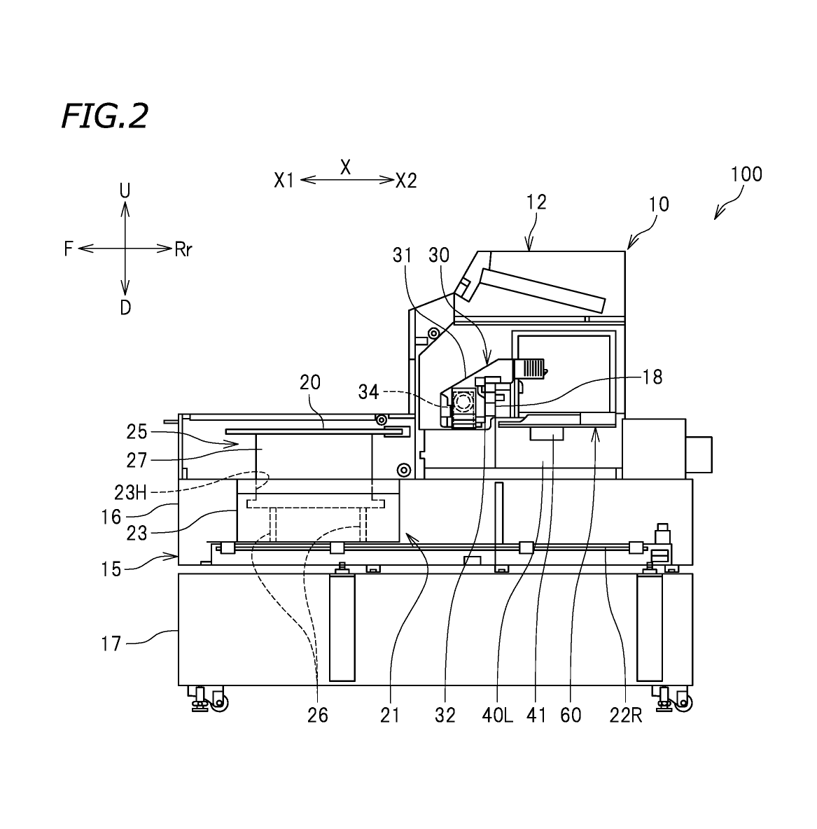

FIG. 1 is a perspective view illustrating a printing system 100 according to a preferred embodiment of the present invention. FIG. 2 is a side view of the printing system 100. FIG. 2 illustrates a state in which a cover located at a side of the printing system 100 is detached for convenience of description. As illustrated in FIG. 1, the printing system 100 includes a printer 10 that performs printing on a recording medium 5 and an air blower 60. The recording medium 5 is, for example, a recording sheet. The recording medium 5 is not limited to a recording sheet. Examples of the recording medium 5 include relatively thick media such as sheets made of resin materials exemplified by PVC and polyester, metal plates made of aluminum or iron, glass plates, and wood plates.

In the following description, left, right, up, and down respectively refer to left, right, up, and down seen from an operator at the front of the printer 10. The direction toward the operator from the printer 10 will be hereinafter referred to as forward, and the opposite direction away from the operator will be hereinafter referred to as rearward. Characters F, Rr, L, R, U, and D in the drawings represent front, rear, left, right, up, and down, respectively. Character X in the drawings represents sub-scanning direction. In this preferred embodiment, a sub-scanning direction X is a front-rear direction. Character Y in the drawings represents a main scanning direction. The main scanning direction Y is a direction intersecting with the sub-scanning direction X (e.g., direction perpendicular to the sub-scanning direction X in plan view). The rear side of the printer 10 will be referred to as an upstream side, and the front side of the printer 10 will be referred to as a downstream side. In this preferred embodiment, a direction from the upstream side toward the downstream side will be referred to as a forward direction X1, and a direction from the downstream side toward the upstream side will be referred to as a backward direction X2. The directions described above, however, are only defined for convenience of description, and should not be restrictive.

As illustrated in FIG. 1, the printer 10 includes a body unit 12, a support base 15, a table 20, an ink head unit 30, and a print controller 80. The table 20 is an example of a placing table. The body unit 12 extends in the main scanning direction Y. A left front cover 13L is disposed at a front left portion of the body unit 12. A right front cover 13R is disposed at a front right portion of the body unit 12. The left front cover 13L and the right front cover 13R are able to be opened and closed with respect to the body unit 12. The support base 15 is attached to a lower portion of the body unit 12. The support base 15 supports the body unit 12. The support base 15 extends in the sub-scanning direction X. The support base 15 is disposed at the right of the left front cover 13L. The support base 15 is disposed at the left of the right front cover 13R. The support base 15 includes a case body 16 housing the table 20 and a leg 17 supporting the case body 16. The case body 16 is open upward. The leg 17 is attached to a lower portion of the case body 16. The ink head unit 30 is disposed inside the body unit 12. The ink head unit 30 is disposed above the table 20. As illustrated in FIG. 2, the ink head unit 30 includes ink heads 34 and a head carriage 32 on which the ink heads 34 are mounted.

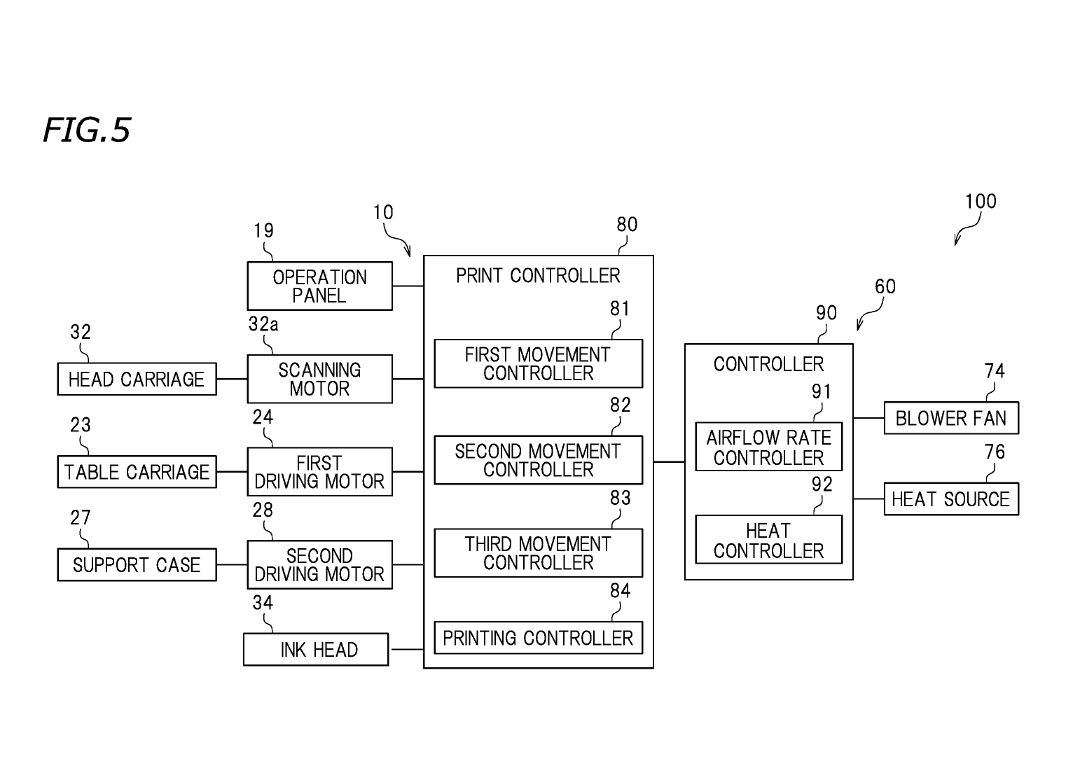

As illustrated in FIG. 1, the printer 10 includes a body frame 14 disposed in the body unit 12. The body frame 14 is an example of a body member. The body frame 14 extends in the main scanning direction Y. The body frame 14 is disposed above the table 20. The printer 10 includes a guide rail 18 disposed on the body frame 14. The guide rail 18 extends in the main scanning direction Y. The guide rail 18 is disposed along the front surface of the body frame 14. The head carriage 32 of the ink head unit 30 is slidably engaged with the guide rail 18. The head carriage reciprocates along the guide rail 18 in the main scanning direction Y by a scanning motor 32a (see FIG. 5) of a carriage moving mechanism (not shown).

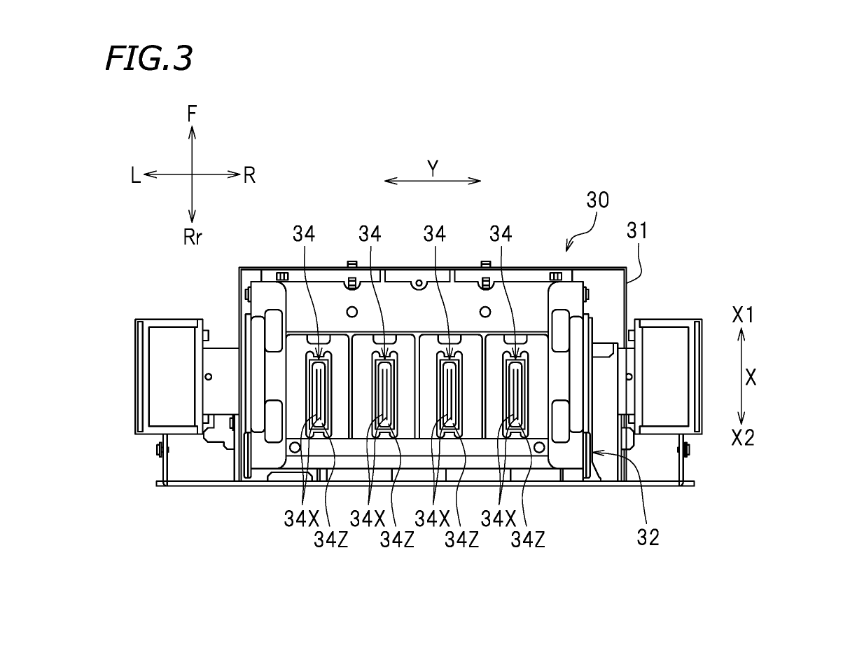

As illustrated in FIG. 1, the ink head unit 30 includes a case 31. The case 31 is attached to the head carriage 32. The ink heads 34 are housed in the case 31. As illustrated in FIG. 3, the ink head unit 30 includes the plurality of ink heads 34. The ink heads 34 are arranged in the main scanning direction Y. Each of the ink heads 34 includes a plurality of nozzles 34X arranged in the sub-scanning direction X and a nozzle surface 34Z provided with the plurality of nozzles 34X. The nozzles 34X discharge ink onto the recording medium 5 placed on the table 20. The nozzles 34X are minute, and thus, the plurality of nozzles 34X are represented by a straight line in FIG. 3. In this preferred embodiment, each ink head 34 includes two lines of nozzles 34X, but may include a single line of nozzles or three or more lines of nozzles, for example. The ink heads 34 are movable along the guide rail 18 in the main scanning direction Y with the head carriage 32 interposed between the ink heads 34 and the guide rail 18.

As illustrated in FIG. 1, the recording medium 5 is placed on the table 20. The table 20 preferably has a rectangular or substantially rectangular shape that is longer in the front-rear direction than in the left-right direction. The table 20 may be larger in the front-rear direction than in the left-right direction or may be the same in length the front-rear direction and in the left-right direction. As illustrated in FIG. 2, the table 20 is disposed below the guide rail 18. The table 20 is disposed below the ink head unit 30. Ink is discharged from the nozzles 34X of the ink heads 34 onto the recording medium 5 placed on the table 20. The table 20 is movable in the sub-scanning direction X by a first moving mechanism 21 described later. The table 20 is movable upward and downward by a second moving mechanism 25 described later.

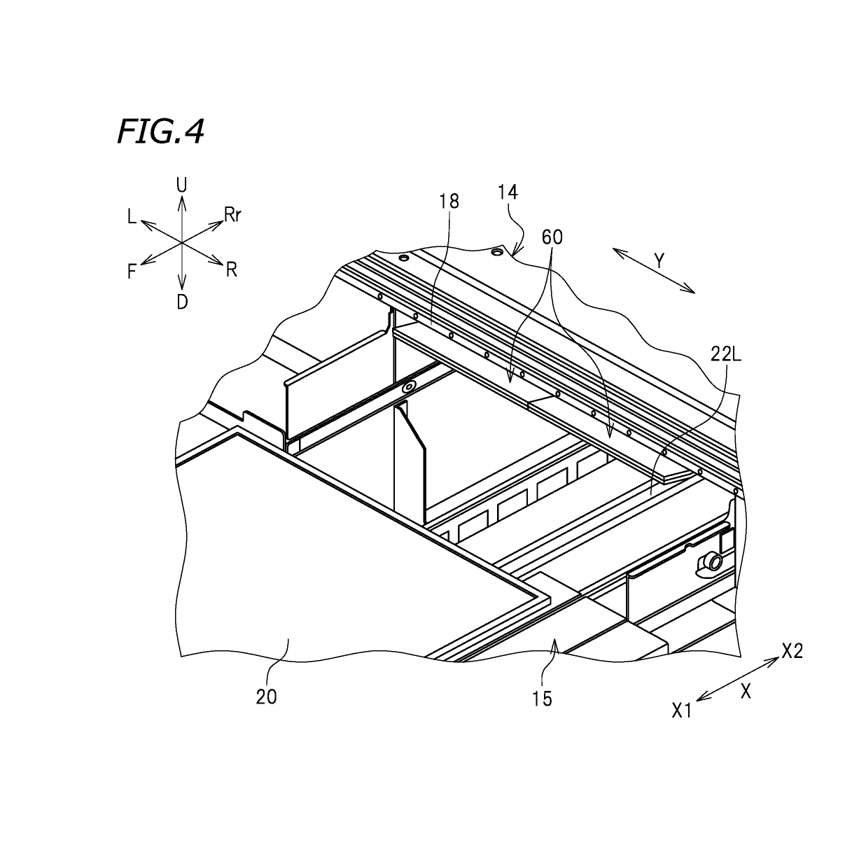

As illustrated in FIG. 2, the printer 10 includes the first moving mechanism 21. The first moving mechanism 21 is housed in the case body 16 of the support base 15. The first moving mechanism 21 includes a left guide rail 22L (see FIG. 4), a right guide rail 22R (see FIG. 2), a table carriage 23, and a first driving motor 24 (see FIG. 5). The left guide rail 22L and the right guide rail 22R extend in the sub-scanning direction X. The left guide rail 22L and the right guide rail 22R are disposed in the case body 16. The left guide rail 22L and the right guide rail 22R guide movement of the table carriage 23 in the sub-scanning direction X. The table carriage 23 is slidably engaged with the left guide rail 22L and the right guide rail 22R. The table carriage 23 preferably has a box shape. The table carriage 23 includes an opening 23H that is open upward (see FIG. 2). The first driving motor 24 is connected to the table carriage 23. The first driving motor 24 is electrically connected to the print controller 80. When the first driving motor 24 is driven to rotate, the table carriage 23 is allowed to move on the left guide rail 22L and the right guide rail 22R in the sub-scanning direction X, that is, in the forward direction X1 and the backward direction X2. That is, the first moving mechanism 21 is able to move the table 20 in the sub-scanning direction X.

As illustrated in FIG. 2, the printer 10 includes the second moving mechanism 25. The second moving mechanism 25 is housed in the table carriage 23 of the first moving mechanism 21. The second moving mechanism 25 includes a plurality of guide struts (for example, four guide struts 26), a support case 27, and a second driving motor 28 (see FIG. 5). The guide struts 26 extend upward and downward. The guide struts 26 are disposed in the table carriage 23 of the first moving mechanism 21. The guide struts 26 guide upward and downward movement of the support case 27. The support case 27 supports the table 20. The table 20 is fixed to an upper portion of the support case 27. The support case 27 is slidably engaged with the guide struts 26. The support case 27 preferably has a box shape. The support case 27 is movable upward and downward with respect to the table carriage 23. The second driving motor 28 is connected to the support case 27. The second driving motor 28 is electrically connected to the print controller 80. When the second driving motor 28 is driven to rotate, the support case 27 is able to move upward and downward along the guide struts 26.

As illustrated in FIG. 1, an operation panel 19 is disposed on a front right portion of the body unit 12. The operation panel 19 is provided with a display that displays a status of the printer 10, an input key operated by a user, and so forth. The operation panel 19 is disposed behind the right front cover 13R. The operation panel 19 is connected to the print controller 80 that controls operations of the printer 10.

As illustrated in FIG. 5, the printing system 100 includes the print controller 80. The print controller 80 is a device that controls printing on the recording medium 5. The print controller 80 is not limited to a specific configuration. The print controller 80 is, for example, a microcomputer. The microcomputer is not limited to a specific hardware architecture, and includes, for example, an interface (I/F) that receives printing data and other data from external equipment such as a host computer, a central processing unit (CPU) that executes an instruction of a control program, a read only memory (ROM) that stores programs to be executed by the CPU, a random access memory (RAM) that is used as a working area where programs are developed, and a memory that stores the programs, the data, and so forth. The print controller 80 is disposed inside the body unit 12. The print controller 80 does not need to be disposed inside the body unit 12, and may be a computer disposed outside the body unit 12, for example. In this case, the print controller 80 is communicably connected to the printer 10 by wires or wirelessly.

As illustrated in FIG. 5, in this preferred embodiment, the print controller 80 is communicably connected to the operation panel 19, the scanning motor 32a of the carriage moving mechanism, the driving motor 24 of the first moving mechanism 21, the second driving motor 28 of the second moving mechanism 25, and the ink heads 34. The print controller 80 controls the operation panel 19, the scanning motor 32a, the first driving motor 24, the second driving motor 28, and the ink heads 34. The print controller 80 includes a first movement controller 81 that controls driving of the scanning motor 32a to control movement of the head carriage 32 in the main scanning direction Y. The print controller 80 includes a second movement controller 82 that controls driving of the first driving motor 24 to control movement of the table carriage 23 in the sub-scanning direction X. The second movement controller 82 moves the table carriage 23 in the sub-scanning direction X so that the table 20 can move relative to the ink heads 34 in the sub-scanning direction X. That is, the second movement controller 82 enables the recording medium 5 placed on the table 20 to move relative to the ink heads 34 in the sub-scanning direction X. After discharging of ink from the ink heads 34 onto the recording medium 5 has been completed, the second movement controller 82 moves the table 20 in such a manner that a printing region onto which ink has been discharged onto the recording medium 5 passes under vents 72 of the air blower 60 that will be described later. The second movement controller 82 may move the table carriage 23 in the sub-scanning direction X by controlling driving of the first driving motor 24 in such a manner that the table 20 reciprocates a predetermined number of times between a printing start position and a printing end position. The print controller 80 includes a third movement controller 83 that controls driving of the second driving motor 28 to control upward and downward movement of the support case 27. The third movement controller 83 enables the table 20 to move upward and downward relative to the ink heads 34 by moving the support case 27 upward and downward. That is, the third movement controller 83 enables the recording medium 5 placed on the table 20 to move upward and downward relative to the ink heads 34. The print controller 80 includes a printing controller 84 that controls the time when the ink heads 34 discharge ink onto the recording medium 5, for example. The functions of these elements of the print controller 80 may be implemented by a program. This program may be read from a recording medium such as a CD and a DVD. The program may be downloaded through the Internet. The functions of the elements of the print controller 80 may be implemented by, for example, processor(s) and/or circuit(s).

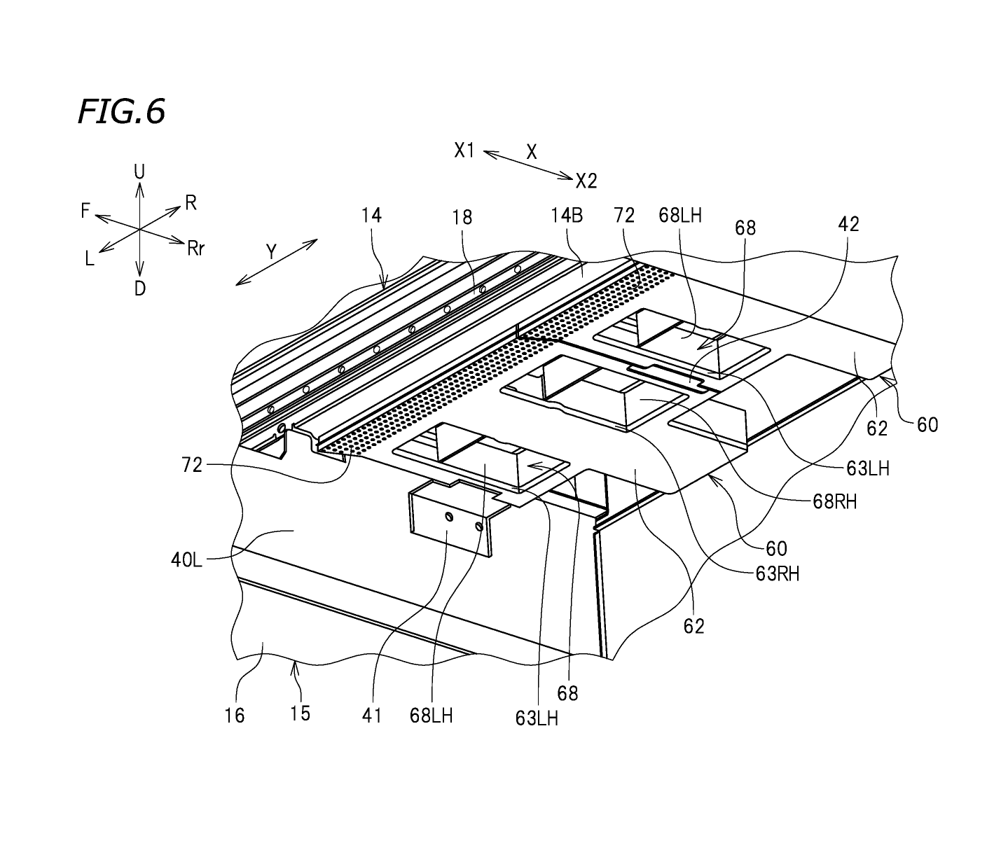

The foregoing description has been directed to the printer 10. Next, the air blower 60 will be described. The air blower 60 is a device that sends air toward the recording medium 5. The air blower 60 is a device that sends air toward the recording medium 5 on the table 20 to heat the surface of the recording medium 5. The air blower 60 is a device that sends air toward ink discharged onto the recording medium 5 placed on the table 20 to dry the ink. As illustrated in FIG. 1, the air blower is attached to the printer 10. More specifically, as illustrated in FIG. 2, the air blower 60 is disposed above the table 20 and upstream (behind in this example) of the ink heads 34 in the sub-scanning direction X. The air blower 60 is disposed on the upstream side of (behind in this example) the guide rail 18 in the sub-scanning direction X. FIG. 6 is a perspective view as seen obliquely from below illustrating an attachment state of the air blower 60. As illustrated in FIG. 6, the air blower 60 is disposed on a lower surface 14B of the body frame 14 located below the guide rail 18. The lower surface 14B faces the table 20. In this preferred embodiment, two air blowers 60 arranged in the main scanning direction Y are attached to the printer 10. The number of air blowers 60 attached to the printer 10 is not limited to a specific number, and may be determined as appropriated depending on the length of the recording medium 5 in the main scanning direction Y. The left air blower 60 is supported by a first suspension member 41 disposed on a left frame member 40L on the body unit 12 and a second suspension member 42 disposed on the lower surface 14B of the body frame 14.

As illustrated in FIG. 12, the first suspension member 41 has an L shape in a front view. The second suspension member 42 has a T shape in the front view. The left frame member 40L is disposed at a side of the left front cover 13L. The right air blower 60 is supported by the second suspension member 42 and a third suspension member 43 disposed on a right frame member 40R on the body unit 12. The third suspension member 43 has an L shape in the front view. The right frame member 40R is disposed at a side of the right front cover 13R. In FIG. 12, for convenience of description, the air blower 60 and the table 20, for example, are not shown.

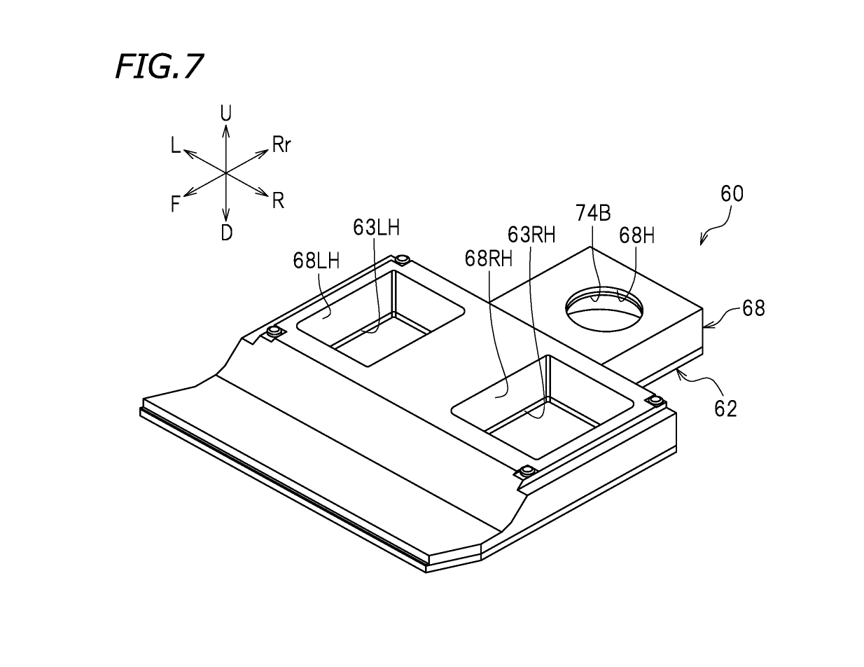

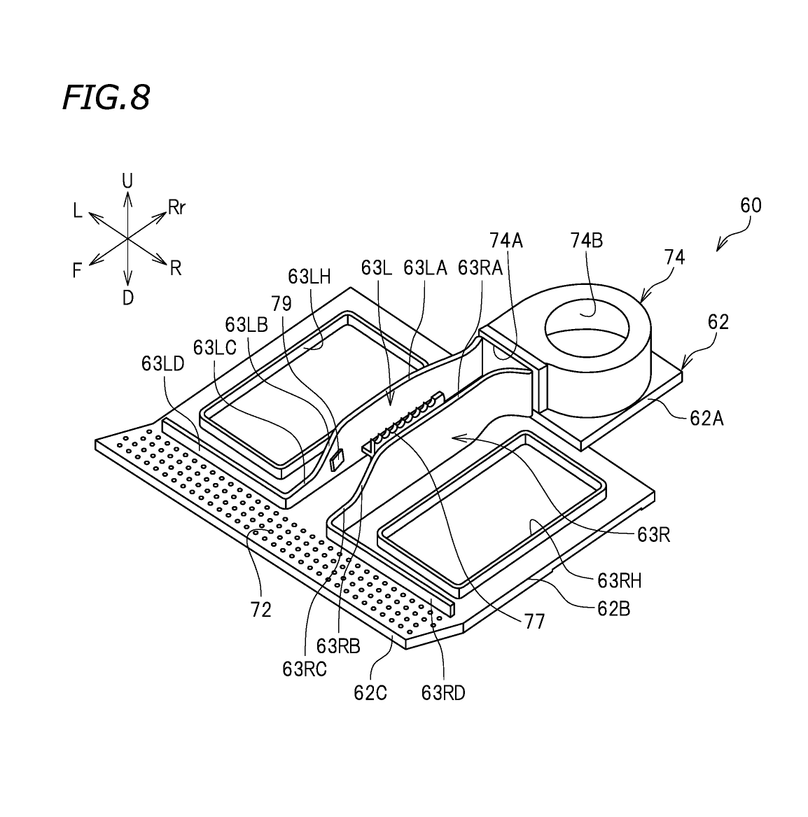

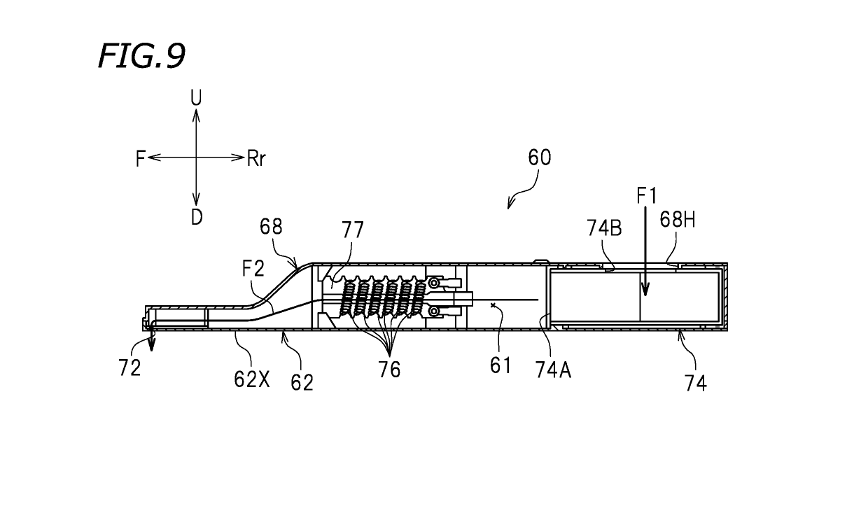

As illustrated in FIG. 7, the air blower 60 includes an opposing plate 62 and a case 68. As illustrated in FIG. 8, the air blower 60 includes the plurality of vents 72 penetrating the opposing plate 62, a blower fan 74, and a heat source 76 (see FIG. 9). As illustrated in FIG. 7, the case 68 is attached to the opposing plate 62, and defines internal space 61 (see FIG. 9) together with the opposing plate 62. The case 68 has a through hole 68LH that communicates with a through hole 63LH described later and formed in the opposing plate 62, and a through hole 68RH that communicates with a through hole 63RH. The case 68 has a through hole 68H. The through hole 68H is located above a suction port 74B of the blower fan 74. Air outside the air blower 60 is sucked into the suction port 74B through the through hole 68H of the case 68.

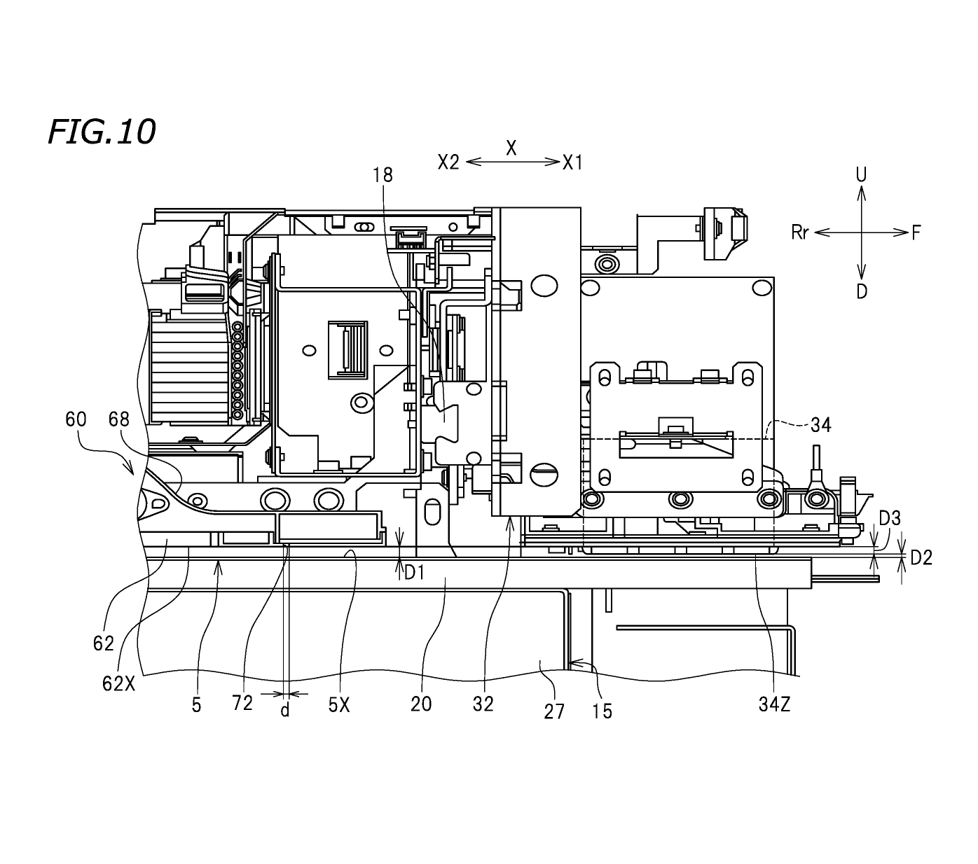

As illustrated in FIG. 10, the opposing plate 62 is disposed above the table 20 and on the upstream side of the ink heads 34 in the sub-scanning direction X. The opposing plate 62 when being attached to the body frame 14 is located at a position facing the table 20. Suppose the diameter of each vent 72 in the opposing plate 62 is d, a distance D1 from a lower surface 62X of the opposing plate 62 to a surface 5X of the recording medium 5 placed on the table 20 is, for example, about 1.5 d or more and about 4 d or less. In this preferred embodiment, the distance D1 is 2d. The opposing plate 62 is located above the nozzle surfaces 34Z of the ink heads 34. Here, suppose a distance from the nozzle surfaces 34Z to the surface 5X of the recording medium 5 placed on the table 20 is D2, the opposing plate 62 is located above the nozzle surfaces 34Z by a distance D3 (D1−D2), for example.

As illustrated in FIG. 8, the opposing plate 62 includes a first portion 62A on which the blower fan 74 is disposed, a second portion 62B on which the heat source 76 (see FIG. 9) is disposed, and a third portion 62C on which the vents 72 are provided. The first portion 62A is shorter than the second portion 62B in the left-right direction. A portion of internal space 61 defined by the second portion 62B and the case 68 is narrower than a portion of internal space 61 defined by the third portion 62C and the case 68.

The second portion 62B is located between the first portion 62A and the third portion 62C in the width direction (in the main scanning direction Y in attachment). The second portion 62B is located ahead of the first portion 62A and behind the third portion 62C in the front-rear direction (in the sub-scanning direction X in attachment).

The second portion 62B is provided with a left wall 63L and a right wall 63R that define the internal space 61 (see FIG. 9) together with the case 68 (see FIG. 9). The left wall 63L includes a left body 63LA extending in the front-rear direction, a left slope 63LB that declines forward from the front end of the left body 63LA, a first left extension 63LC extending forward from the left slope 63LB, and a second left extension 63LD extending leftward from the first left extension 63LC. The right wall 63R includes a right body 63RA extending in the front-rear direction, a right slope 63RB that declines forward from the front end of the right body 63RA, a first right extension 63RC extending forward from the right slope 63RB, and a second right extension 63RD extending rightward from the first right extension 63RC. An air-supply port 74A of the blower fan 74 described later is disposed between the rear end of the left body 63LA of the left wall 63L and the rear end of the right body 63RA of the right wall 63R. The second portion 62B of the opposing plate 62 includes a rectangular through hole 63LH located at the left of the left wall 63L and penetrating the second portion 62B in the top-bottom direction, and a rectangular through hole 63RH located at the right of the right wall 63R and penetrating the second portion 62B in the top-bottom direction.

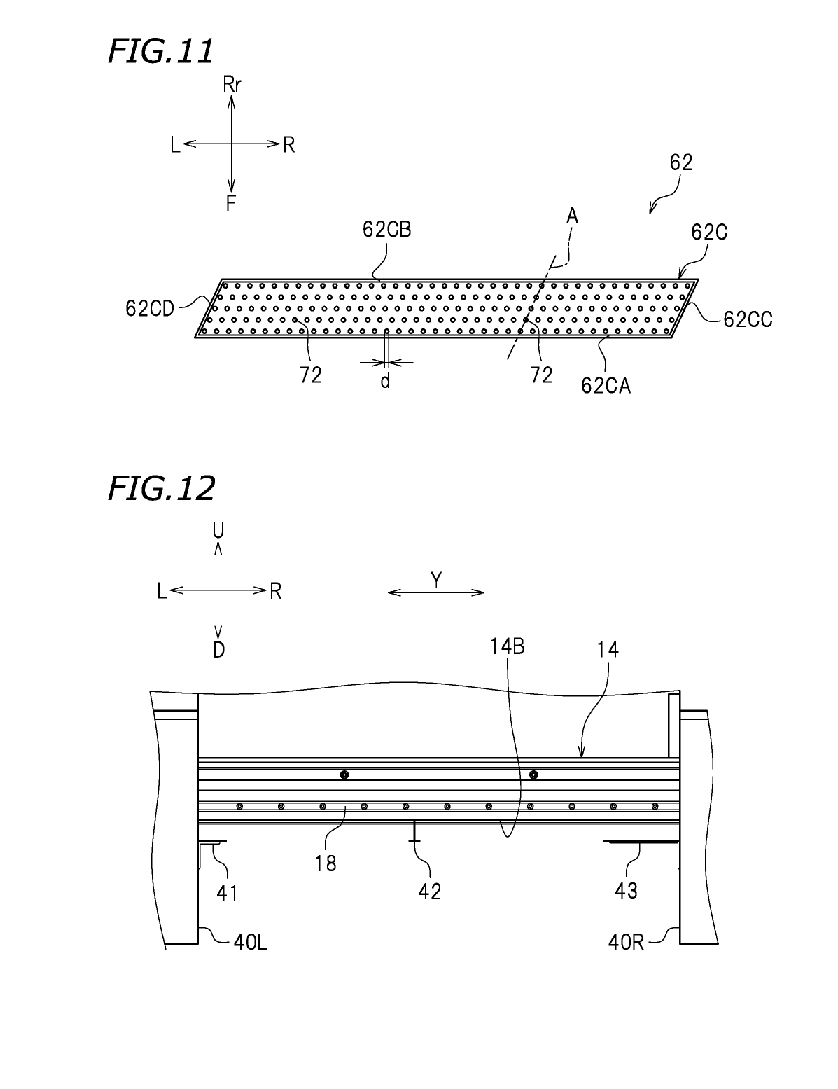

As illustrated in FIG. 11, the third portion 62C preferably has a parallelogram shape, for example. That is, the third portion 62C includes a first side 62CA extending in the left-right direction, a second side 62CB disposed in parallel or substantially in parallel with the first side 62CA and located behind the first side 62CA, a third side 62CC extending obliquely rightward and rearward from the right end of the first side 62CA, and a fourth side 62CD disposed in parallel or substantially in parallel with third side 62CC and extending obliquely rightward and rearward from the left end of the first side 62CA. The plurality of vents 72 in the third portion 62C and arranged in the front-rear direction are arranged in such a manner that a straight line A connecting the plurality of vents 72 is parallel or substantially parallel to the third side 62CC and the fourth side 62CD. Thus, when the left air blower 60 and the right air blower 60 are disposed in such a manner that the third side 62CC of the left air blower 60 and the fourth side 62CD of the right air blower 60 are in contact with each other, air also flows uniformly from the vents 72 toward the recording medium 5 near a junction between the left and right air blowers 60 in a manner similar to the third portion 62C. The vents 72 communicate with the internal space 61. As illustrated in FIG. 10, the vents 72 are located on the upstream side of the guide rail 18 in the sub-scanning direction X. In this preferred embodiment, the vents 72 are located behind the guide rail 18.

As illustrated in FIG. 9, the heat source 76 is disposed in the internal space 61 of the air blower 60. The heat source 76 generates heat. The heat source 76 is disposed between the blower fan 74 and the vents 72. A support member 77 provided with the heat source 76 is disposed between the left body 63LA of the left wall 63L and the right body 63RA of the right wall 63R in the opposing plate 62. The heat source 76 is not limited to a specific configuration. For example, the heat source 76 is a nichrome wire heater. In this preferred embodiment, the nichrome wire heater as the heat source 76 is wound around the support member 77.

As illustrated in FIG. 8, the blower fan 74 is disposed in the internal space 61 of the air blower 60. The blower fan 74 is disposed on the upstream side of (behind in this example) the heat source 76. The blower fan 74 includes the air-supply port 74A and the suction port 74B. The suction port 74B is open upward. As indicated by arrow F1 in FIG. 9, when the blower fan 74 is driven, air outside the air blower 60 is sucked in the suction port 74B through the through hole 68H of the case 68. The air-supply port 74A is open toward the heat source 76. The air-supply port 74A allows air to flow toward the vents 72. As indicated by arrow F2 in FIG. 9, air sent from the air-supply port 74A is heated while passing through the heat source 76. Thereafter, the heated air is sent to the recording medium 5 through the vents 72. The blower fan 74 sends air toward a portion of the recording medium 5 located on the upstream side of (behind in this example) the ink heads 34 before ink is discharged from the ink heads 34 onto the recording medium 5. The blower fan 74 sends air toward the portion of the recording medium 5 located on the upstream side of the ink heads 34 while ink is being discharged from the ink heads 34 onto the recording medium 5. The blower fan 74 sends air toward the portion of the recording medium 5 located on the upstream side of the ink heads 34 while the table 20 is moved by the first moving mechanism 21 from an upstream side toward a downstream side in the sub-scanning direction X (in the direction indicated by arrow X1 in FIG. 2). The blower fan 74 sends air toward ink discharged onto the recording medium 5 after discharging of ink from the ink heads 34 onto the recording medium 5 has been completed. The blower fan 74 sends air toward the ink discharged onto the recording medium 5 while the table 20 is moved by the first moving mechanism 21 from a downstream side toward an upstream side in the sub-scanning direction X (in a direction indicated by arrow X2 in FIG. 2).

As illustrated in FIG. 8, the air blower 60 includes a temperature sensor 79. The temperature sensor 79 is disposed on the opposing plate 62. Here, the temperature sensor 79 is disposed on a portion of the left wall 63L located on a downstream side of (ahead of in this example) the heat source 76, and detects the temperature of air that has been sent from the air-supply port 74A of the blower fan 74 and passed through the heat source 76. That is, the temperature sensor 79 detects the temperature of air flowing on the recording medium 5 through the vents 72. The temperature sensor 79 is not limited to a specific installation position and a specific type. For example, the temperature sensor 79 may be disposed on the case 68 of the air blower 60. The temperature sensor 79 is, for example, a thermistor.

As illustrated in FIG. 5, the air blower 60 includes a controller 90. The controller 90 is a device that controls air that is sent to the recording medium 5. The controller 90 is not limited to a specific configuration. The controller 90 is, for example, a microcomputer. The microcomputer is not limited to a specific hardware architecture, and includes, for example, an interface (I/F) that receives printing data and other data from external equipment such as a host computer, a CPU, a ROM, a RAM, and a memory. The controller 90 preferably is disposed inside the air blower 60. The controller 90 does not need to be disposed inside the air blower 60, and may be a computer disposed outside the air blower 60, for example. In this case, the controller 90 is communicably connected to the air blower 60 by wires or wirelessly.

As illustrated in FIG. 5, in this preferred embodiment, the controller 90 is communicably connected to the blower fan 74, the heat source 76, and the temperature sensor 79. The controller controls the blower fan 74 and the heat source 76. The controller 90 includes an airflow rate controller 91 that controls an airflow rate of the blower fan 74. The airflow rate controller 91 controls the airflow rate of the blower fan 74 in such a manner that a first airflow rate that is an airflow rate of the blower fan 74 while ink is being discharged from the ink heads 34 onto the recording medium 5 is smaller than a second airflow rate that is an airflow rate of the blower fan 74 after discharging of ink from the ink heads 34 onto the recording medium 5 is completed. The first airflow rate is about 0.2 m³/min to about 0.4 m³/min, for example. The second airflow rate is approximately about 0.4 m³/min to about 0.7 m³/min, for example. The airflow rate controller 91 controls, for example, the time when air is sent from the blower fan 74 to the recording medium 5 through the vents 72. The controller 90 includes a heat controller 92 that controls the heat source 76 to control the quantity and intensity of heat generated by the heat source 76. The functions of these elements of the controller 90 is implemented by a program. This program may be read from a recording medium such as a CD and a DVD. The program may be downloaded through the Internet. The functions of the elements of the controller 90 may be implemented by, for example, processor(s) and/or circuit(s).

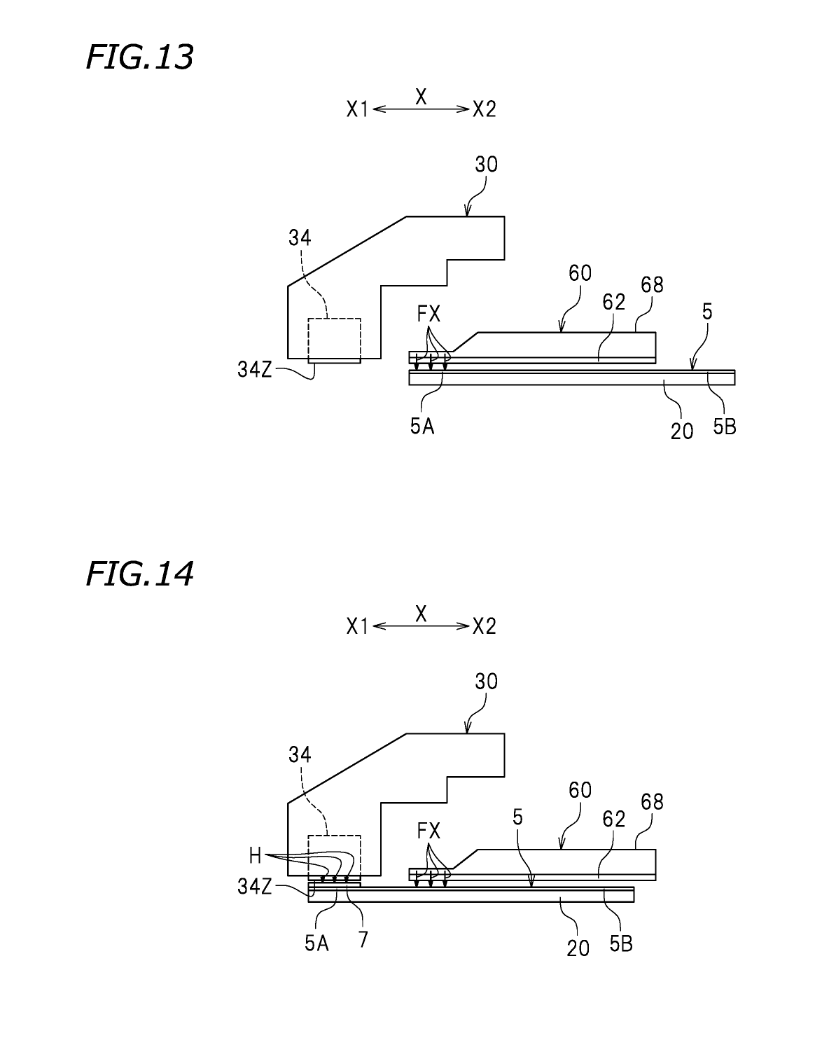

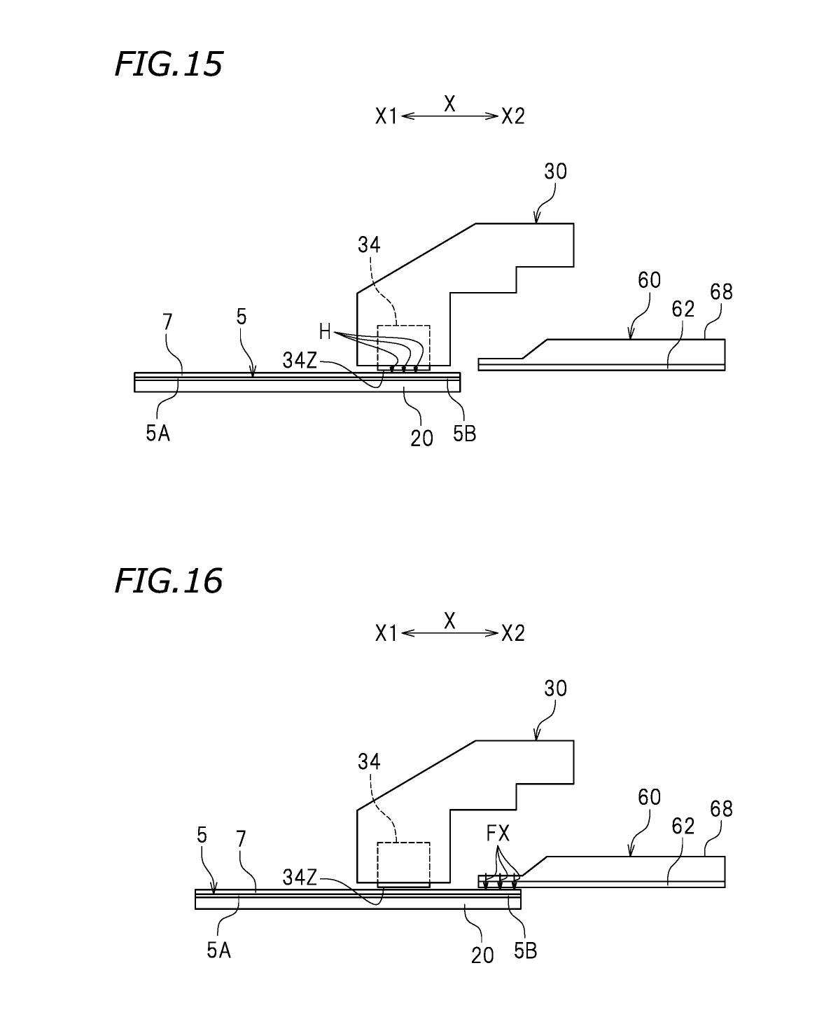

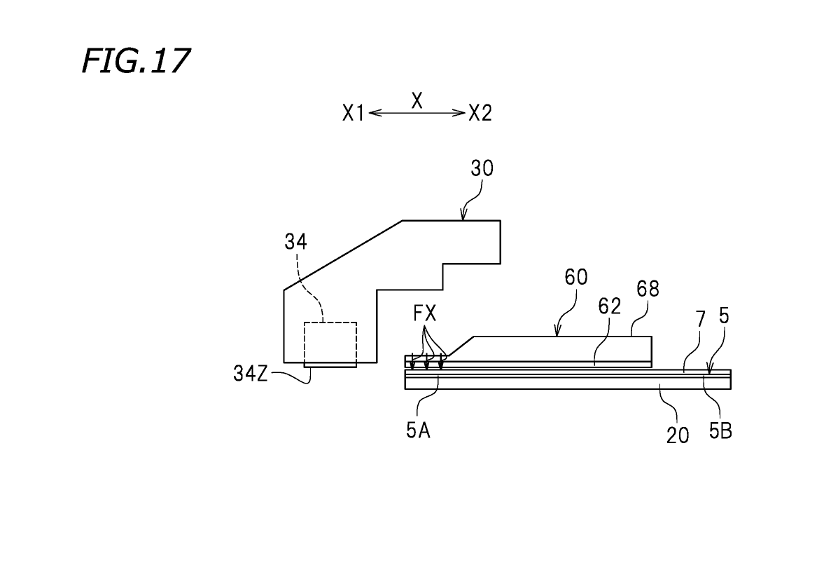

The foregoing description has been directed to the configuration of the air blowers 60. Next, an operation of the printing system 100 in performing printing on the recording medium will be described. As illustrated in FIG. 13, the second movement controller 82 moves the table 20 in the backward direction X2 in such a manner that a downstream end 5A of the recording medium 5 is located under the vents 72 of the air blower 60 with the recording medium 5 being placed on the table 20. Thereafter, the airflow rate controller 91 drives the air blower 60, and as indicated by arrow FX in FIG. 13, air sent from the blower fan 74 starts being sent to the surface of the recording medium 5 through the vents 72. The air sent from the blower fan 74 is heated by the heat source 76, and thus, the surface of the recording medium 5 is able to be heated. While the second movement controller 82 moves the table 20 in the forward direction X1, the airflow rate controller 91 sends the heated air to the surface of the recording medium 5. Accordingly, the surface of the recording medium 5 is gradually heated from a downstream side toward an upstream side. Thereafter, when the recording medium 5 comes to be located under the ink heads 34 as illustrated in FIG. 14, the printing controller 84 controls the ink heads 34 as indicated by arrow H in FIG. 14 so that ink is discharged from the nozzles 34X of the ink heads 34 onto the recording medium 5. In this manner, an ink layer 7 is formed on the surface of the recording medium 5. At this time, while ink is being discharged from the ink heads 34, the surface of the recording medium 5 is heated by the air blower 60 on the upstream side of the ink heads 34. As illustrated in FIG. 15, the second movement controller 82 further moves the table 20 in the forward direction X1 and, at the same time, the printing controller 84 causes the ink heads 34 to discharge ink onto the recording medium 5. Thus, printing on the recording medium 5 is thus completed, and an ink layer 7 is formed on the surface of the recording medium 5. At this time, since the recording medium 5 is not located under the air blower 60, the air blower 60 is stopped. The air blowers 60 may be constantly driven. Thereafter, as illustrated in FIG. 16, the second movement controller 82 moves the table 20 in the backward direction X2 in such a manner that an upstream end 5B of the recording medium 5 is located under the vents 72 of the air blower 60. Subsequently, the airflow rate controller 91 drives the air blower 60, and as illustrated by arrow FY in FIG. 16, air sent from the blower fan 74 starts being sent to the ink layer 7 formed on the surface of the recording medium 5, through the vents 72. The second airflow rate of the blower fan 74 after completion of printing on the recording medium 5 is larger than the first airflow rate of the blower fan 74 during printing. Then, as illustrated in FIG. 17, until the downstream end 5A of the recording medium 5 comes to be located under the vents 72 of the air blower 60, the heated air is continuously sent toward the ink layer 7 formed on the surface of the recording medium 5 while the table 20 is moved in the backward direction X2. In this manner, drying of the ink layer 7 is promoted. Thereafter, the following reciprocation operation may be performed repeatedly. In this reciprocation operation, while air is sent from the air blowers 60 to the ink layer 7, the table 20 is moved in the forward direction X1 until the upstream end 5B of the recording medium 5 comes to be located under the vents 72 of the air blower 60, and then, the table 20 is moved in the backward direction X2 until the downstream end 5A of the recording medium 5 comes to be located under the vents 72 of the air blower 60.

As described above, in the air blower 60 according to this preferred embodiment, air flowing from the blower fan 74 through the vents 72 is heated by the heat source 76 disposed between the blower fan 74 and the vents 72. Accordingly, heated air is sent to the surface of the recording medium 5 so that the surface of the recording medium 5 is heated. Here, before ink is discharged from the ink heads 34 onto the recording medium 5 and while ink is being discharged from the ink heads 34 onto the recording medium 5, the blower fan 74 of the air blower 60 sends air to the recording medium 5 located on the upstream side of the ink heads 34. Accordingly, the surface of the recording medium 5 is able to be heated before ink is discharged onto the recording medium 5, and thus, fixing of the ink discharged onto the recording medium 5 is able to be enhanced. The blower fan 74 sends air toward ink discharged onto the recording medium 5 after discharging of ink from the ink heads 34 onto the recording medium 5 has been completed. Accordingly, drying of ink discharged onto the surface of the recording medium 5 is promoted. As described above, the air blower 60 is able to perform preliminary heating of the recording medium 5 and drying of ink in accordance with a progress status of printing on the recording medium 5. That is, the single air blower 60 is able to perform both preliminary heating of the recording medium 5 and drying of ink, and thus, installation space is able to be reduced.

In the air blower 60 according to this preferred embodiment, the blower fan 74 sends air toward the recording medium 5 located on the upstream side of the ink heads 34 when the table is moved by the first moving mechanism 21 in the forward direction X1. Thus, the surface of the recording medium 5 is able to be heated before ink is discharged onto the recording medium 5. The blower fan 74 is also able to send air toward the ink discharged onto the recording medium 5 when the table 20 is moved by the first moving mechanism 21 in the backward direction X2. Accordingly, drying of ink discharged onto the surface of the recording medium 5 is promoted.

In the air blower 60 according to this preferred embodiment, the airflow rate controller 91 controls the airflow rate of the blower fan 74 in such a manner that the first airflow rate that is an air flow rate of the blower fan 74 while ink is being discharged from the ink heads 34 onto the recording medium 5 is smaller than the second airflow rate that is an airflow rate of the blower fan 74 after discharging of ink from the ink heads 34 onto the recording medium 5 has been completed. While ink is discharged from the ink heads 34 onto the recording medium 5, if the airflow rate of the blower fan 74 is too large, a shift might occur in an impacting location of ink. Thus, the first airflow rate is preferably relatively small. On the other hand, after discharging of ink from the ink heads 34 onto the recording medium 5 has been completed, drying of ink discharged onto the recording medium 5 is able to be promoted by increasing the airflow rate of the blower fan 74. Thus, the second airflow rate is preferably relatively large.

In the printing system 100 according to the present preferred embodiment, the opposing plate 62 is located above the nozzle surfaces 34Z. Since the opposing plate 62 is located above the nozzle surfaces 34Z, interference between the opposing plate 62 and the recording medium 5 is able to be reduced or prevented. In addition, since the distance D3 between the nozzle surfaces 34Z and the recording medium 5 is relatively small, in a configuration in which the opposing plate 62 is located below the nozzle surfaces 34Z, a heat transfer coefficient by heated air flowing to the recording medium 5 through the vents 72 might decrease. In this preferred embodiment, however, since the opposing plate 62 is located above the nozzle surfaces 34Z, the decrease in heat transfer coefficient is able to be reduced or prevented.

In the printing system 100 according to this preferred embodiment, the air blower 60 is located below the guide rail 18 of the body frame 14, and is disposed on the lower surface 14B facing the table 20. In this manner, the air blower 60 is able to be disposed on the lower surface 14B of the body frame 14 so that space between the body frame 14 and the table 20 is able to be effectively used. Furthermore, since the air blower 60 is disposed in the body frame 14, an increase in size of the printing system 100 is able to be reduced or prevented.

In the printing system 100 according to the present preferred embodiment, the plurality of vents 72 in the opposing plate 62 are located on the upstream side of (ahead of in this example) the guide rail 18 in the sub-scanning direction X. With this configuration, since ink is discharged from the ink heads 34 onto the recording medium 5 in a relatively early stage at a high surface temperature of the recording medium 5, fixing of ink onto the recording medium 5 is able to be enhanced.

In the printing system 100 according to this preferred embodiment, after discharging of ink from the ink heads 34 onto the recording medium 5 is completed, the second movement controller 82 moves the table 20 in such a manner that the ink layer 7 formed by discharging ink on the recording medium 5 passes under the vents 72 of the air blower 60. In this manner, drying of ink discharged onto the recording medium 5 is promoted.

In the printing system 100 according to this preferred embodiment, the printer 10 includes the second moving mechanism 25 that moves the table 20 upward and downward relative to the ink heads 34. Accordingly, irrespective of the thickness of the recording medium 5, heated air is able to be efficiently sent from the blower fan 74 to the recording medium 5.

The foregoing description is directed to the preferred embodiments of the present invention. The preferred embodiments described above, however, are merely examples, and the present invention can be performed in various modes.

In the preferred embodiments described above, the table 20 is moved in the sub-scanning direction X relative to the ink heads 34. However, the present invention is not limited to this example. For example, the table 20 may be fixed to the support base 15 so that the body unit 12 is able to be moved in the sub-scanning direction X relative to the table 20.

In the preferred embodiments described above, the table is moved upward and downward relative to the ink heads 34. However, the present invention is not limited to this example. For example, the table 20 may be fixed to the support base 15 so that the ink heads 34 are able to be moved upward and downward relative to the table 20.

In the preferred embodiments described above, the blower fan 74 is driven to send air to the recording medium 5 moving in each of the forward direction X1 and the backward direction X2. However, the present invention is not limited to this example. For example, the following process may be performed. That is, in this process, air is sent from the blower fan 74 to the recording medium 5 moving in the forward direction X1 so that printing is performed with the recording medium 5 preheated, and then, the table 20 is temporarily returned in the backward direction X2 (during this returning, the blower fan 74 is stopped), and air is sent from the blower fan 74 to the recording medium 5 moving in the forward direction X1 so that ink discharged onto the recording medium 5 is able to be dried.

The terms and expressions used herein are for description only and are not to be interpreted in a limited sense. These terms and expressions should be recognized as not excluding any equivalents to the elements shown and described herein and as allowing any modification encompassed in the scope of the claims. The present invention may be embodied in many various forms. This disclosure should be regarded as providing preferred embodiments of the principle of the present invention. These preferred embodiments are provided with the understanding that they are not intended to limit the present invention to the preferred embodiments described in the specification and/or shown in the drawings. The present invention is not limited to the preferred embodiments described herein. The present invention encompasses any of preferred embodiments including equivalent elements, modifications, deletions, combinations, improvements and/or alterations which can be recognized by a person of ordinary skill in the art based on the disclosure. The elements of each claim should be interpreted broadly based on the terms used in the claim, and should not be limited to any of the preferred embodiments described in this specification or referred to during the prosecution of the present application.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An air blower provided in an ink jet printer, the ink jet printer including a placing table on which a recording medium is placed, an ink head movable in a main scanning direction and including a nozzle that discharges ink onto the recording medium placed on the placing table and a nozzle surface provided with the nozzle, and a first moving mechanism that moves one of the placing table and the ink head relative to another in a sub-scanning direction perpendicular or substantially perpendicular to the main scanning direction, the air blower being structured to send air toward the recording medium, the air blower comprising:
an opposing plate disposed above the placing table and on an upstream side of the ink head in the sub-scanning direction;
a plurality of vents penetrating the opposing plate;
a case defining an internal space together with the opposing plate;
a blower fan that is disposed in the internal space, causes air to flow toward the vents, and sends air to the recording medium through the vents; and
a heat source that is disposed between the vents and the blower fan in the internal space and generates heat; wherein
the blower fan sends air toward a portion of the recording medium located on the upstream side of the ink head before ink is discharged from the ink head onto the recording medium or while ink is being discharged from the ink head onto the recording medium, and the blower fan sends air toward ink discharged onto the recording medium after discharging of ink from the ink head onto the recording medium is completed.

2. The air blower according to claim 1, wherein the blower fan sends air toward the portion of the recording medium located on the upstream side of the ink head when the placing table is moved by the first moving mechanism from the upstream side toward a downstream side in the sub-scanning direction, and the blower fan sends air toward ink discharged onto the recording medium when the placing table is moved by the first moving mechanism from the downstream side toward the upstream side in the sub-scanning direction.

3. The air blower according to claim 1, further comprising an airflow rate controller that controls an airflow rate of the blower fan, wherein
the airflow rate controller controls the airflow rate of the blower fan such that a first airflow rate that is an airflow rate of the blower fan while ink is being discharged from the ink head onto the recording medium is smaller than a second airflow rate that is an airflow rate of the blower fan after discharging of ink from the ink head onto the recording medium is completed.

4. A printing system comprising:
the air blower according to claim 1; and
the ink jet printer including the placing table, the ink head, and the first moving mechanism.

5. The printing system according to claim 4, wherein the opposing plate is located above the nozzle surface.

6. The printing system according to claim 4, wherein the ink jet printer includes:
a body disposed above the placing table and extending in the main scanning direction;
a guide rail disposed on the body and extending in the main scanning direction; and
a carriage slidably provided on the guide rail, the ink head being mounted on the carriage; wherein
the air blower is located below the guide rail on the body and disposed on a surface of the body member facing the placing table.

7. The printing system according to claim 6, wherein the plurality of vents in the opposing plate are located on the upstream side of the guide rail in the sub-scanning direction.

8. The printing system according to claim 4, wherein
the ink jet printer includes a movement controller that controls the first moving mechanism;
the first moving mechanism moves the placing table relative to the ink head in the sub-scanning direction; and
the movement controller moves the placing table after discharging of ink from the ink head onto the recording medium is completed such that a printing region on the recording medium onto which ink has been discharged passes under the vents in the air blower.

9. The printing system according to claim 4, wherein the ink jet printer includes a second moving mechanism that moves one of the placing table and the ink head upward and downward relative to another.
